(19) United States
(12) Patent Application Publication
(10) Pub. No.: US 2016/0126595 A1
(43) Pub. Date: May 5, 2016

(54) MOLTEN SALT BATTERY

(71) Applicants: SUMITOMO ELECTRIC INDUSTRIES, LTD., Osaka-shi (JP); KYOTO UNIVERSITY, Kyoto-shi (JP)

(72) Inventors: Atsushi FUKUNAGA, Osaka-shi (JP); Koji NITTA, Osaka-shi (JP); Shoichiro SAKAI, Osaka-shi (JP); Koma NUMATA, Osaka-shi (JP); Eiko IMAZAKI, Osaka-shi (JP); Rika HAGIWARA, Kyoto-shi (JP); Toshiyuki NOHIRA, Kyoto-shi (JP); Kazuhiko MATSUMOTO, Kyoto-shi (JP)

(21) Appl. No.: 14/895,904

(22) PCT Filed: Feb. 21, 2014
(86) PCT No.: PCT/JP2014/054152

§ 371 Date: Dec. 3, 2015

(30) Foreign Application Priority Data
Jun. 10, 2013 (JP) 2013-121925

(51) Int. Cl. H01M 10/0569; H01M 4/587; H01M 4/485; H01M 10/054; H01M 4/58

(52) U.S. Cl. CPC H01M 10/0569; H01M 10/054; H01M 4/5825; H01M 4/485; H01M 4/587; H01M 2004/028

(57) ABSTRACT

A molten salt battery is provided which includes a positive electrode including a positive-electrode active material represented by the general formula: Aₙ₍₁₋ₓ₎M¹ₙₓFe_{1-y}M²_{y}P₂O₇ (wherein n is 1 or 2, 0≦x≦0.5, 0≦y≦0.5, A is an alkali metal element, M¹ is an element other than the element A, M² is an element other than Fe), a negative electrode including a negative-electrode active material, a separator interposed between the positive electrode and the negative electrode, and a molten salt electrolyte. The molten salt electrolyte contains 90% by mass or more of an ionic liquid containing a salt of the element A.

### TECHNICAL FIELD

The present invention relates to a molten salt battery containing a pyrophosphate as a positive-electrode active material, and more particularly, to a molten salt battery having an excellent charge/discharge property at a high temperature.

### BACKGROUND ART

In recent years, there is a growing demand for a nonaqueous electrolyte secondary battery as a high-energy density battery capable of storing electrical energy. Among nonaqueous electrolyte secondary batteries, a lithium ion secondary battery including lithium cobalt oxide as a positive-electrode active material provides a high capacity and a high voltage, and is becoming common in practical use. However, cobalt and lithium are highly expensive, and in addition, many of lithium ion secondary batteries are known to get unstable in an overcharge condition. Thus, increasing attention has been directed to a sodium ion secondary battery including olivine-type sodium iron phosphate (chemical formula: NaFePO₄), which is less costly and more stable. Among them, pyrophosphate Na₂FePO₇, which contains twice as much sodium as olivine-type sodium iron phosphate per iron atom, achieves high potential, and thus energy density can be expected to be improved (Non-Patent Literature 1).

Meanwhile, there has been developed a molten salt battery including a flame-retardant molten salt electrolyte, having excellent thermal stability. As the molten salt electrolyte, there is proposed, for example, an ionic liquid which is a salt of an organic cation and an anion (Patent Literature 1). An ionic liquid is a promising material for an electrolyte in a secondary battery, because the ionic liquid has high ion conductivity, a wide temperature range of liquid phase, a low vapor pressure, and non-flammability. In addition, since the ionic liquid is hardly decomposable even at a high temperature, a secondary battery including an ionic liquid as the electrolyte can be used, for example, at an operating temperature near 100° C.

### CITATION LIST

### Patent Literature

Patent Literature 1: Japanese Unexamined Patent Publication No. 2006-196390

### Non-Patent Literature

Non-Patent Literature 1: Electrochemistry Communications 24 (2012) 116-119

### SUMMARY OF INVENTION

### Technical Problem

As described in Non-Patent Literature 1, pyrophosphate is a promising material for use as a positive-electrode active material in a nonaqueous electrolyte secondary battery, from the viewpoint of safety and energy density. Meanwhile, with the expanding uses of nonaqueous electrolyte secondary batteries, there is a demand for developing a nonaqueous electrolyte secondary battery that can not only be used at ordinary temperatures, but can also be charged and discharged in a temperature range, for example, from 50° C. to 90° C., at a high charge/discharge rate. However, in the case where a pyrophosphate is used, use of an electrolyte including as a main component an organic solvent such as propylene carbonate as described in Non-Patent Literature 1 causes a side reaction accompanied with gas generation to actively progress in a temperature range, for example, around 90° C., and makes it difficult to perform charging and discharging. In addition, the higher charge/discharge rate becomes, a more significant side reaction becomes remarkable, and thus gas generation and a decrease in charge/discharge capacity associated therewith become more significant.

### Solution to Problem

The present invention is directed to a molten salt battery including a positive electrode including a positive-electrode active material represented by the general formula:

Aₙ₍₁₋ₓ₎M¹ₙₓFe_{1-y}M²_{y}P₂O₇

wherein n is 1 or 2, 0≦x≦0.5, 0≦y≦0.5, A is an alkali metal element, M¹ is an element other than the element A, and M² is an element other than Fe,

a negative electrode including a negative-electrode active material,

a separator interposed between the positive electrode and the negative electrode, and

a molten salt electrolyte,

wherein the molten salt electrolyte contains 90% by mass or more of an ionic liquid containing a salt of the element A.

### Advantageous Effects of Invention

A molten salt battery of the present invention is stably chargeable and dischargeable even in a temperature range, for example, from 50° C. to 90° C., and achieves a high capacity even when a high charge/discharge rate is used during charging and discharging.

### BRIEF DESCRIPTION OF DRAWINGS

FIG. 1 is a front view of a positive electrode according to one embodiment of the present invention.

FIG. 2 is a cross-sectional view taken along line II-II of FIG. 1.

FIG. 3 is a front view of a negative electrode according to one embodiment of the present invention.

FIG. 4 is a cross-sectional view taken along line IV-IV of FIG. 3.

FIG. 5 is a perspective view of a molten salt battery after cutting off a portion of the battery casing thereof, according to one embodiment of the present invention.

FIG. 6 is a vertical cross-sectional view schematically illustrating a cross section taken along line VI-VI of FIG. 5.

FIG. 7 is a graph showing charge/discharge curves for first and second cycles of a coin-type battery of Example 1.

FIG. 8 is a graph showing a discharge capacity and a ratio of the discharge capacity to a charge capacity, of the coin-type battery of Example 1.

FIG. 9 is a graph illustrating discharge capacities for respective discharge currents of the coin-type battery of Example 1.

### DESCRIPTION OF EMBODIMENTS

### Summary of Embodiment of Invention

First, a gist of embodiments of the present invention will be listed and explained.

(1) The present embodiment relates to a molten salt battery including a positive electrode including a positive-electrode active material represented by the general formula:

Aₙ₍₁₋ₓ₎M¹ₙₓFe_{1-y}M²_{y}P₂O₇

wherein n is 1 or 2, 0≦x≦0.5, 0≦y≦0.5, A is an alkali metal element, M¹ is an element other than the element A, and M² is an element other than Fe,

a negative electrode including a negative-electrode active material,

a separator interposed between the positive electrode and the negative electrode, and

a molten salt electrolyte,

wherein the molten salt electrolyte contains 90% by mass or more of an ionic liquid containing a salt of the element A (this salt is hereinafter also referred to as first salt). The configuration described above permits the molten salt battery to be stably charged and discharged even in a temperature range, for example, from 50° C. to 90° C., and to achieve a high capacity even when a high charge/discharge rate is used during charging and discharging.

(2) The positive-electrode active material is preferably

Na₂₋₂ₓM¹₂ₓFe_{1-y}M²_{y}P₂O₇

wherein 0≦x≦0.1, 0≦y≦0.1, M¹ is an element other than sodium, and M² is an element other than Fe,
and a salt of the element A is preferably a sodium salt. This can provide a molten salt battery having an excellent charge/discharge property at low cost.

(3) The positive-electrode active material is preferably, for example, Na₂FeP₂O₇. This can provide a molten salt battery having an excellent charge/discharge property at even lower cost. Moreover, such a positive-electrode active material is easy to produce.

(4) The ionic liquid preferably includes a salt of an anion and a cation (this salt is hereinafter also referred to as second salt), the anion being represented by the general formula:

[(R¹SO₂)(R²SO₂)]N⁻

wherein each of R¹ and R² is independently F or CₙF₂ₙ₊₁, and 1≦n≦5. This further improves the heat resistance and ion conductivity of the molten salt battery.

(5) The negative-electrode active material is preferably at least one selected from a group consisting of an element A-containing titanium compound , and a graphitization-retardant carbon. This provides a molten salt battery having improved thermal stability and electrochemical stability.

### Details of Embodiment of Invention

A concrete example of an embodiment of the present invention will be described below. It is construed that the scope of the present invention is not limited to such examples, but is defined by the claims and all modifications fall within the scope of the claim and the equivalent thereof are intended to be embraced by the claim.

### Positive Electrode

The positive electrode includes a positive-electrode active material represented by the general formula:

Aₙ₍₁₋ₓ₎M¹ₙₓFe_{1-y}M²_{y}P₂O₇

wherein n is 1 or 2, 0≦x≦0.5, and 0≦y≦0.5, A is an alkali metal element, M¹ is an element other than the element A, and M² is an element other than Fe (this positive-electrode active material is hereinafter also referred to as “A iron pyrophosphate”). An A iron pyrophosphate has a pyrophosphate structure, and contains at least iron atom as the redox center. While the value of n can be 1 or 2, it is preferable that n is 2 (n=2) from the viewpoint of achieving a high capacity. When n is 2 (n=2), the iron atom is changed between divalent and trivalent accompanying charging and discharging.

It is considered that the A iron pyrophosphate has a triclinic crystal structure. It is considered that, in a molten salt electrolyte, a very high degree of freedom is achieved in diffusion of the element A inside such crystal structure. Moreover, this trend is thought to intensify as the temperature is increased. In contrast, the molten salt electrolyte is stable even at a high temperature, and thus decomposition due to a side reaction does not occur. Therefore, even if the molten salt battery is charged or discharged in a temperature range, for example, from 50° C. to 90° C., gas generation is prevented or reduced, and a high capacity is achieved even when a high charge/discharge rate is used during charging and discharging. When an electrolyte including as a main component an organic solvent such as propylene carbonate is used it is difficult to charge and to discharge the battery at a high temperature.

The element A is an alkali metal element. As the element A, there can be concretely exemplified by sodium, lithium, potassium, rubidium, and cesium. Among them, sodium is preferred since a molten salt battery having an excellent charge/discharge property can be achieved at low cost.

The element M¹ is an element other than the element A. The element M¹ includes, for example, an alkali metal element other than the element A. For example, when the element A is sodium, the element M¹ can include at least one selected from a group consisting of potassium, cesium, and lithium. The element M¹ occupies a site that is crystallographically equivalent to a site occupied by the element A.

The element M² is an element other than Fe. Particularly, the element M² includes Cr, Mn, Ni, Co, and the like. Among them, Mn is preferred since Mn achieves a high reversibility in charging and discharging. The element M² can include solely a single element, or a plural kinds of elements. The element M² occupies a site that is crystallographically equivalent to a site occupied by Fe.

The value of n is 1 or 2. It is preferable that n is 2 (n=2). The value of x satisfies 0≦x≦0.5. The value of x is preferably within a range of 0≦x≦0.1. Too large a value of x tends to decrease the capacity of the positive-electrode active material. The value of y satisfies 0≦y≦0.5. The value of y is preferably within a range of 0≦y≦0.1. Too large a value of y tends to degrade reversibility in charging and discharging. The positive-electrode active material represented by the general formula:

Aₙ₍₁₋ₓ₎M¹ₙₓFe_{1-y}M²_{y}P₂O₇

can be used alone or in admixture of a plural kinds thereof. For example, an A iron pyrophosphate satisfying n=1 and an A iron pyrophosphate satisfying n=2 can be used in combination.

A preferred A iron pyrophosphate is represented by the general formula:

Na₂₋₂ₓM¹₂ₓFe_{1-y}M²_{y}P₂O₇

wherein 0≦x≦0.1, 0≦y≦0.1, M¹ is an element other than sodium, and M² is an element other than Fe. In this case, the molten salt electrolyte contains 90% by mass or more of an ionic liquid containing a sodium salt. Among them, the A iron pyrophosphate is preferably Na₂FeP₂O₇. This can provide a molten salt battery having an excellent charge/discharge property at even lower cost. Moreover, such a positive-electrode active material is easy to produce.

An alkali metal-containing metal oxide, which is a material other than the A iron pyrophosphate, that electrochemically adsorbs and releases an alkali metal ion can be contained as a positive-electrode active material. A sodium-containing metal oxide includes, for example, sodium chromite (NaCrO₂), iron sodium manganate (Na_{2/3}Fe_{1/3}Mn_{2/3}O₂, and the like), Na₂FePO₄F, NaVPO₄F, NaCoPO₄, NaNiPO₄, NaMnPO₄, NaMn_{1.5}Ni_{0.5}O₄, NaMn_{0.5}Ni_{0.5}O₂, and the like. The alkali metal-containing metal oxide can be used alone or in admixture of a plural kinds thereof.

The average particle diameter of the positive-electrode active material(s) is preferably 2 μm or more, and 20 μm or less. Such particle diameter range tends to allow a homogeneous positive-electrode active material layer to be formed, and thus electrode reactions tend to proceed smoothly. An average particle diameter is the median diameter in a particle size distribution by volume obtained by a particle size distribution measurement system that uses laser diffraction.

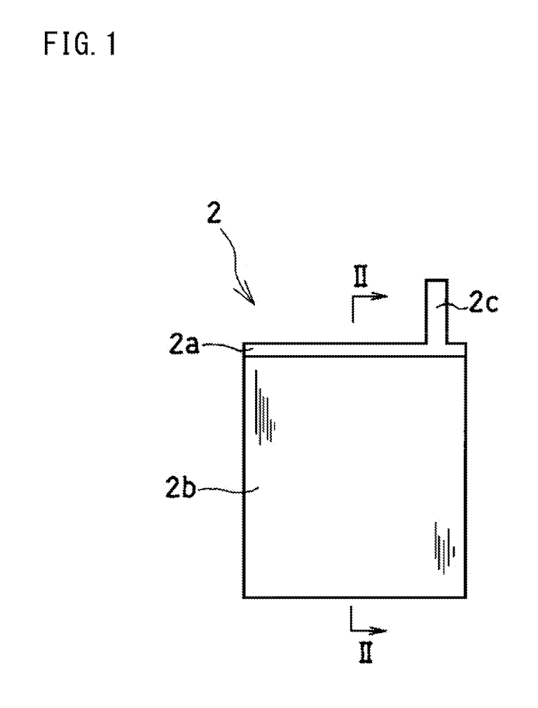

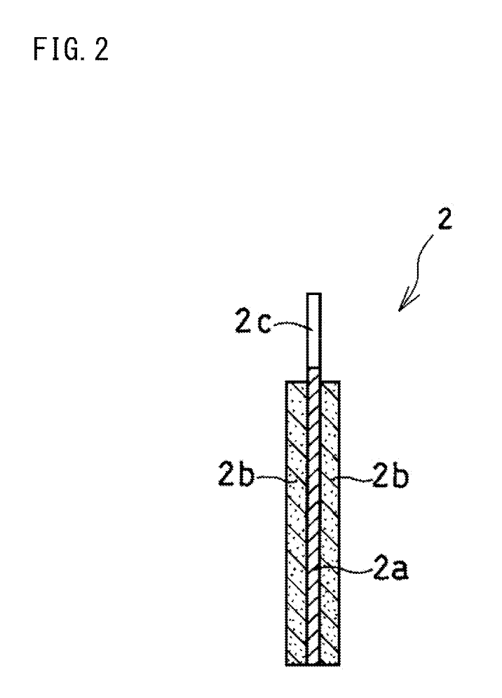

FIG. 1 is a front view of a positive electrode according to one embodiment of the present invention, and FIG. 2 is a cross-sectional view taken along line II-II of FIG. 1.

A positive electrode 2 for the molten salt battery includes a positive-electrode current collector 2a and a positive-electrode active material layer 2b adhered to the positive-electrode current collector 2a. The positive-electrode active material layer 2b contains a positive-electrode active material as an essential component. The positive-electrode active material layer 2b can contain as an optional component an electrically conductive carbon material, a binder, and the like.

Examples of the electrically conductive carbon material to be contained in the positive electrode include graphite, carbon black, carbon fiber, and the like. Among the electrically conductive carbon materials, carbon black is particularly preferred since it is likely that a small amount of carbon black provides a sufficient electrically conductive path. Examples of carbon black include acetylene black, Ketjen Black, thermal black, and the like. The content of the electrically conductive carbon material is preferably 2 to 15 parts by mass, and more preferably 3 to 8 parts by mass, per 100 parts by mass of the positive-electrode active material.

The binder serves to bind particles of the positive-electrode active material together, and to fix the positive-electrode active material onto the positive-electrode current collector. As the binder, there can be used a fluororesin, a polyamide, a polyamide-imide, and the like. As the fluororesin, there can be used polyvinylidene fluoride (PVDF), polytetrafluoroethylene (PTFE), tetrafluoroethylene-hexafluoropropylene copolymer, vinylidene fluoride-hexafluoropropylene copolymer, and the like. The content of the binder is preferably 1 to 10 parts by mass, and more preferably 3 to 5 parts by mass, per 100 parts by mass of the positive-electrode active material.

As the positive-electrode current collector 2a, there can be used a metal foil, a nonwoven fabric made of a metal fabric, a porous metal sheet, and the like. The metal which forms the positive-electrode current collector is preferably aluminum or an aluminum alloy, from the viewpoint of its stability at a potential of the positive electrode, but is not particularly limited. When the aluminum alloy is used, the content of the metal component(s) other than aluminum (for example, Fe, Si, Ni, Mn, and the like) is preferably 0.5% by mass or less. The thickness of the metal foil that forms the positive-electrode current collector is, for example, 10 to 50 μm. The thicknesses of the nonwoven fabric made of metal fabric and of the porous metal sheet are each, for example, 100 to 600 μm. A positive-electrode lead piece 2c for collecting current can be formed on the positive-electrode current collector 2a. The positive-electrode lead piece 2c can be monolithically formed with the positive-electrode current collector as shown in FIG. 1, or can be implemented by connecting a separately-formed lead piece to the positive-electrode current collector by welding or other method.

### Molten Salt Electrolyte

The molten salt electrolyte contains 90% by mass or more of an ionic liquid containing a salt of the element A (first salt). The ionic liquid can be a compound in liquid state in the operating temperature range of the molten salt battery. A molten salt electrolyte is advantageous in high heat resistance and non-flammability. Therefore, it is desirable that the molten salt electrolyte include components other than the ionic liquid as little as possible. However, various additives and organic solvents can be included in the molten salt electrolyte in an amount which does not significantly reduce the heat resistance and non-flammability. To avoid reduction in the heat resistance and non-flammability, the ionic liquid containing the first salt preferably accounts for 95 to 100% by mass of the molten salt electrolyte.

The first salt is a salt of a cation of the element A and an anion, the cation being a cation of an alkali metal element. The anion is preferably a polyatomic anion, and can be exemplified by, for example, PF₆₋, BF₄₋, ClO₄₋, and an anion represented as [(R¹SO₂)(R²SO₂)]N⁻ (wherein each of R¹ and R² is independently F or CₙF₂ₙ₊₁, and 1≦n≦5) (this anion is hereinafter also referred to as bis(sulfonyl)amide anion). Among them, a bis(sulfonyl)amide anion is preferred from the viewpoint of heat resistance and ion conductivity of the molten salt battery.

Particularly, a bis(sulfonyl)amide anion includes bis(fluorosulfonyl)amide anion, (fluorosulfonyl)(perfluoroalkylsulfonyl)amide anion, and bis(perfluoroalkylsulfonyl)amide anion (PFSA−:bis(pentafluoroethylsulfonyl)imide anion). The number of carbon atoms in the perfluoroalkyl group is, for example, 1 to 5, preferably 1 to 2, and more preferably 1. These anions can be used alone or in admixture of two or more kinds thereof.

Among of the bis(sulfonyl)amide anions, bis(fluorosulfonyl)amide anion (FSA−), bis(trifluoromethylsulfonyl)amide anion (TFSA−), bis(pentafluoroethylsulfonyl)amide anion, (fluorosulfonyl)(trifluoromethylsulfonyl)amide anion, and the like are preferred.

When the element A is sodium, concrete examples of the first salt include a salt of sodium ion and FSA−(Na.FSA), a salt of sodium ion and TFSA−(Na.FSA), and the like.

In some cases, the first salt can alone account for 90% by mass or more of the ionic liquid, depending on the operating temperature or the application of the molten salt battery. However, the ionic liquid is preferably a mixture with a salt other than the first salt. In this case, the melting point of the ionic liquid, and the melting point of the molten salt electrolyte can be lowered.

That is, the ionic liquid preferably includes, as the salt other than the first salt, a salt (second salt) of an anion, such as PF₆₋, BF₄₋, ClO₄₋, or a bis(sulfonyl)amide anion, and a cation. In this case, the heat resistance and ion conductivity of the molten salt battery is further improved. Among them, a bis(sulfonyl)amide anion is preferred. Concrete examples of bis(sulfonyl)amide anions can be listed as the same compounds as those listed above.

Examples of the cation of the second salt include an organic cation and an alkali metal cation other than that of the element A. The organic cations can be exemplified by a nitrogen-containing cation, a sulfur-containing cation, a phosphorus-containing cation, and the like. The nitrogen-containing cation can be exemplified by a cation derived from an aliphatic amine, an alicyclic amine or an aromatic amine (for example, a quaternary ammonium cation, and the like), an organic cation each having a nitrogen-containing heterocyclic ring (that is, a cation derived from a cyclic amine), and the like.

The quaternary ammonium cations includes, for example, a tetraalkylammonium cation (a tetra-C₁₋₁₀ alkylammonium cation, and the like), and the like, the tetraalkylammonium cation including tetramethylammonium cation, ethyltrimethylammonium cation, hexyltrymethylammonium cation, ethyltrimethylammonium cation (TEA+), methyltriethylammonium cation (TEMA+), and the like.

The sulfur-containing cation includes a tertiary sulfonium cation such as a trialkylsulfonium cation (for example, a tri-C₁₋₁₀ alkylsulfonium cation, and the like), the trialkylsulfonium cation including, for example, trimethylsulfonium cation, trihexylsulfonium cation, dibutylethylsulfonium cation, and the like.

The phosphorus-containing cation includes, for example, a quaternary phosphonium cation, and the like, the quaternary phosphonium cation including a tetraalkylphosphonium cation (for example, a tetra-C₁₋₁₀ alkylphosphonium cation), such as tetramethylphosphonium cation, tetraethylphosphonium cation, and tetraoctylphosphonium cation; an alkyl(alkoxyalkyl)phosphonium cation (for example, a tri-C₁₋₁₀ alkyl(C₁₋₅ alkoxy C₁₋₅ alkyl)phosphonium cation, and the like), such as triethyl(methoxymethyl)phosphonium cation, diethylmethyl(methoxymethyl)phosphonium cation, and trihexyl(methoxyethyl)phosphonium cation. The total number of an alkyl group and an alkoxyalkyl group which are bonded to a phosphorus atom in an alkyl(alkoxyalkyl)phosphonium cation is four, and the number of alkoxyalkyl groups is preferably one or two.

The number of the carbon atoms in each of the alkyl groups bonded to the nitrogen atom of a quaternary ammonium cation, to the sulfur atom of a tertiary sulfonium cation, and to the phosphorus atom of a quaternary phosphonium cation is preferably 1 to 8, more preferably 1 to 4, and particularly preferably 1, 2, or 3.

Here, the organic cation is preferably an organic cation having a nitrogen-containing heterocyclic ring. An ionic liquid which contains an organic cation having a nitrogen-containing heterocyclic ring achieves high heat resistance and low viscosity, and thus is a promising molten salt electrolyte. The nitrogen-containing heterocyclic ring skeleton of the organic cation can be exemplified by a 5 to 8-membered heterocyclic ring having one or two nitrogen atoms as a ring-forming atom, such as pyrrolidine, imidazoline, imidazole, pyridine, piperidine, and the like; and a 5 to 8-membered heterocyclic ring having one or two nitrogen atoms and other hetero atom(s) (oxygen atom, sulfur atom, and the like), as a ring member atom, such as morpholine.

A nitrogen atom which is the ring-forming atom can have as a substituent an organic group such as an alkyl group. The alkyl group can be exemplified by an alkyl group having 1 to 10 carbon atoms, such as methyl group, ethyl group, propyl group, and isopropyl group. The number of carbon atoms of the alkyl group is preferably 1 to 8, more preferably 1 to 4, and particularly preferably 1, 2, or 3.

Among the organic cations having nitrogen-containing heterocyclic rings, an organic cation having a pyrrolidine skeleton, in particular, have high heat resistance and low manufacturing cost, and are thus promising molten salt electrolytes. An organic cation having a pyrrolidine skeleton preferably has two of the alkyl groups described above on the nitrogen atom which forms the pyrrolidine ring. An organic cation having a pyridine skeleton preferably has one of the alkyl groups described above on the nitrogen atom which forms the pyridine ring. An organic cation having an imidazoline skeleton preferably has one of the alkyl groups on each of the two nitrogen atoms which forms the imidazoline ring.

Concrete examples of organic cation having a pyrrolidine skeleton include 1,1-dimethylpyrrolidinium cation, 1,1-diethylpyrrolidinium cation, 1-ethyl-1-methylpyrrolidinium cation, 1-methyl-1-propylpyrrolidinium cation (MPPY+), 1-methyl-1-butylpyrrolidinium cation (MBPY+: 1-butyl-1-methylpyrrolidinium cation), 1-ethyl-1-propylpyrrolidinium cation, and the like. Among them, a pyrrolidinium cation having methyl group and an alkyl group having 2 to 4 carbon atoms, such as MPPY+ and MBPY+, is preferred, from the viewpoint of high electrochemical stability in particular.

Concrete examples of organic cation having a pyridine skeleton include a 1-alkylpyridinium cation such as 1-methylpyridinium cation, 1-ethylpyridinium cation, and 1-propylpyridinium cation. Among them, a pyridinium cation having an alkyl group having 1 to 4 carbon atoms is preferred.

Concrete examples of organic cation having an imidazoline skeleton include 1,3-dimethylimidazolium cation, 1-ethyl-3-methylimidazolium cation (EMI+), 1-methyl-3-propylimidazolium cation, 1-butyl-3-methylimidazolium cation (BMI+), 1-ethyl-3-propylimidazolium cation, 1-butyl-3-ethylimidazolium cation, and the like. Among them, an imidazolium cation having methyl group and an alkyl group having 2 to 4 carbon atoms, such as EMI+ and BMI+, is preferred

When the molten salt electrolyte contains 90% by mass or more of a mixture of the first and second salts, and the second salt is a salt of an organic cation and an anion, the concentration of the element A contained in the molten salt electrolyte (equivalent to the concentration of the first salt if the first salt is monovalent) is preferably 2 mol % or more, more preferably 5 mol % or more, and particularly preferably 8 mol % or more, with respect to the cations contained in the molten salt electrolyte. In addition, the concentration of the element A is preferably 30 mol % or less, more preferably 20 mol % or less, and particularly preferably 15 mol % or less, with respect to the cations contained in the molten salt electrolyte. Such molten salt electrolyte has a high second salt content and low viscosity, and is thus advantageous in achieving a high capacity particularly during charging and discharging current at a high rate. Preferred upper and lower limits of the concentration of the element A can be combined in any combination to set a preferred range. For example, a preferred range of the concentration of the element A with respect to all the cations contained in the molten salt electrolyte can be 2 to 20 mol %, and can also be 5 to 15 mol %.

In consideration of a balance between the melting point, viscosity, and ion conductivity of the molten salt electrolyte, the molar ratio of the first salt and the second salt (first salt/second salt), the second salt being a salt of an organic cation and an anion, can be, for example, 2/98 to 20/80, and preferably 5/95 to 15/85.

The alkali metal cation used as the cation of the second salt, the alkali metal cation being a cation other than a cation of the element A, can be exemplified by a cation of sodium, lithium, potassium, rubidium, cesium, and the like. For example, when a cation of the element A is sodium ion, the cation of the second salt is potassium ion, cesium ion, lithium ion, or the like. Cations can be used alone or in admixture of two or more kinds thereof.

When the molten salt electrolyte contains 90% by mass or more of a mixture of the first and second salts, and the second salt is a salt of an alkali metal cation and an anion, the alkali metal cation being a cation other than a cation of the element A, the concentration of the element A contained in the molten salt electrolyte (equivalent to the concentration of the first salt, when the first salt is monovalent) is preferably 30 mol % or more, and more preferably 40 mol % or more, with respect to the cations contained in the molten salt electrolyte. In addition, the concentration of the element A is preferably 70 mol % or less, and more preferably 60 mol % or less, with respect to the cations contained in the molten salt electrolyte. Such molten salt electrolyte has excellent ion conductivity and thus easily achieves high capacity during charging and discharging current at a high rate. Preferred upper and lower limits of the concentration of the element A can be combined in any combination to set a preferred range. For example, a preferred range of the concentration of the element A with respect to all the cations contained in the molten salt electrolyte can be 30 to 70 mol %, and can also be 40 to 60 mol %.

More particularly, when the first salt is a sodium salt and the second salt is a potassium salt, the molar ratio of the first salt to the second salt (first salt/second salt) is, for example, preferably 45/55 to 65/35, and more preferably 50/50 to 60/40 in consideration of a balance between the melting point, viscosity, and ion conductivity of the electrolyte.

Concrete examples of the second salt include a salt of MPPY and FSA−(MPPY.FSA), a salt of MPPY and TFSA−(MPPY.TFSA), a salt of potassium ion and FSA−(K.FSA), a salt of potassium ion and PFSA−(K.PFSA), such as potassium bis(trifluoromethylsulfonyl)amide (K.TFSA).

Concrete examples of the molten salt electrolyte include:

(i) a molten salt electrolyte which contains a salt of sodium ion and FSA−(Na.FSA) as the first salt, and a salt of MPPY and FSA−(MPPY.FSA) as the second salt,

(ii) a molten salt electrolyte which contains a salt of sodium ion and TFSA−(Na.TFSA) as the first salt, and a salt of MPPY and TFSA−(MPPY.TFSA) as the second salt,

(iii) a molten salt electrolyte which contains a salt of sodium ion and FSA−(Na.TSA) as the first salt, and a salt of potassium ion and FSA−(K.TSA) as the second salt, and

(iv) a molten salt electrolyte which contains a salt of sodium ion and TFSA−(Na.TFSA) as the first salt, and a salt of potassium ion and TFSA−(K.TFSA) as the second salt.

The kinds of the salts which are contained in the ionic liquid is not limited to 1 or 2 kinds. The ionic liquid can contain three or more kinds of salts. For example, the molten salt electrolyte can contain 90% by mass or more of a mixture of the first salt, the second salt, and a third salt. The molten salt electrolyte can be a mixture of four or more salts including the first to third salts.

### Negative Electrode

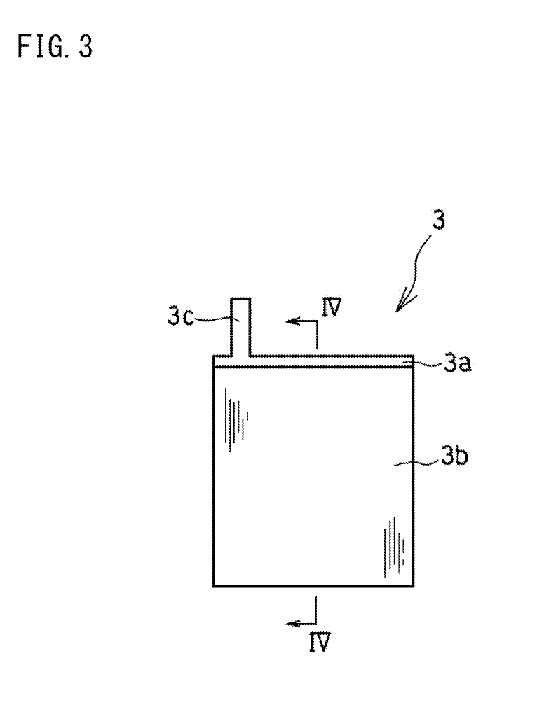

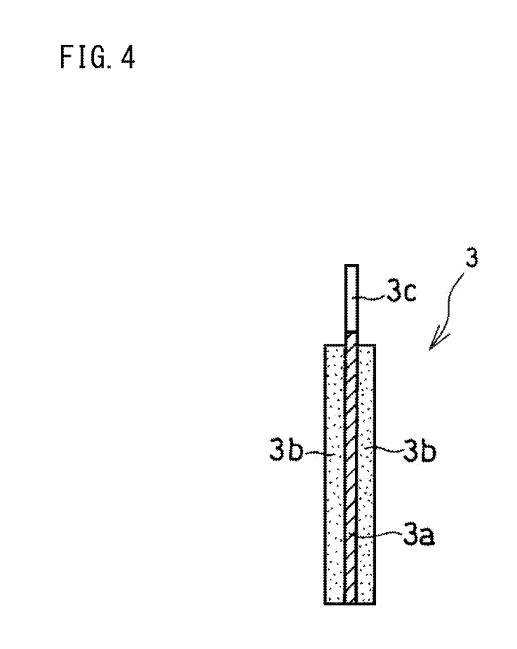

FIG. 3 is a front view of a negative electrode according to one embodiment of the present invention, and FIG. 4 is a cross-sectional view taken along line IV-IV of FIG. 3.

A negative electrode 3 includes a negative-electrode current collector 3a and a negative-electrode active material layer 3b adhered to the negative-electrode current collector 3a.

As the negative-electrode current collector 3a, there can be used a metal foil, a nonwoven fabric made of a metal fabric, a porous metal sheet, or the like. Metal which does not form alloy with sodium can be used as the aforementioned metal. Among them, from the viewpoint of stability at a potential of the negative electrode, aluminum, an aluminum alloy, copper, a copper alloy, nickel, a nickel alloy, and the like are preferred. Among them, the aluminum and the aluminum alloy are preferred, from the viewpoint of low weight. The aluminum alloy can be, for example, one that is similar to those exemplified above as the material of the positive-electrode current collector. The thickness of the metal foil that forms the negative-electrode current collector is, for example, 10 to 50 μm. The thicknesses of the nonwoven fabric made of metal fabric and of the porous metal sheet are each, for example, 100 to 600 μm. A negative-electrode lead piece 3c for collecting current can be formed on the negative-electrode current collector 3a. The negative-electrode lead piece 3c can be monolithically formed with the negative-electrode current collector as shown in FIG. 3, or can be implemented by connecting a separately-formed lead piece to the negative-electrode current collector by welding or other method.

The negative-electrode active material layer 3b can include, as the negative-electrode active material, a metal which can be alloyed with an alkali metal, or a material which electrochemically adsorbs and releases an alkali metal cation. Examples of metal which can be alloyed with sodium include, for example, metal sodium, a sodium alloy, zinc, a zinc alloy, tin, a tin alloy, silicon, a silicon alloy, and the like. Among them, the zinc and the zinc alloy are preferred, from the viewpoint of good wettability to molten salt. The thickness of the negative-electrode active material layer is preferably, for example, 0.05 to 1 μm. The content of the metal component other than zinc or tin (for example, Fe, Ni, Si, Mn, and the like), in a zinc alloy or in a tin alloy, respectively, is preferably 0.5% by mass or less.

When these materials are used, the negative-electrode active material layer 3b can be formed by, for example, attaching or pressure bonding a metal sheet on the negative-electrode current collector 3a. Alternatively, metal can be gasified to be attached to the negative-electrode current collector using a vapor deposition method, such as vacuum vapor deposition or sputtering. Metal particles can be attached to the negative-electrode current collector by using an electrochemical method, such as plating. By a vapor deposition method or plating, a thin and uniform negative-electrode active material layer can be formed.

In addition, from the viewpoint of thermal stability and electrochemical stability, as the material that electrochemically adsorbs and releases an alkali metal cation, an element A-containing titanium compound, a graphitization-retardant carbon (hard carbon), or the like can be preferably used. The element A-containing titanium compound is preferably an alkali metal titanate. Specifically, in the case of a molten sodium battery, which charges and discharges current by sodium ion migration, it is preferable to use at least one selected from a group consisting of Na₂Ti₃O₇ and Na₄Ti₅O₁₂. In addition, Ti or Na atoms in sodium titanate can be partially substituted by atoms of other element. For example, Na₂₋ₓM⁵ₓTi_{3-y}M⁶_{y}O₇ can be used, wherein 0≦x≦3/2 and 0≦y≦8/3. Each of M⁵ and M⁶ is independently a metal element other than Ti and Na. Each of M⁵ and M⁶ is independently, for example, at least one selected from a group consisting of Ni, Co, Mn, Fe, Al, and Cr. Moreover, Na₄₋ₓM⁷ₓTi_{5-y}M⁸_{y}O₁₂ can be used, wherein 0≦x≦11/3 and 0≦y≦14/3. Each of M⁷ and M⁸ is independently a metal element other than Ti and Na. Each of M⁷ and M⁸ is independently, for example, at least one selected from a group consisting of Ni, Co, Mn, Fe, Al, and Cr. The element A-containing titanium compounds can be used alone or in admixture of a plural kinds thereof. The element A-containing titanium compound can be used in combination with a graphitization-retardant carbon. The elements M⁵ and M⁷ occupy Na sites, while the elements M⁶ and M⁸ occupy Ti sites.

The graphitization-retardant carbon refers to a carbon material which does not develop a graphite structure upon being heated in an inert atmosphere, having randomly-oriented graphite microcrystals, and a gap on the order of nanometers between crystal layers. Since the diameter of a sodium ion, which is a representative alkali metal, is 0.95 angstrom, the gap size is preferably sufficiently larger than the diameter of the sodium ion. The average particle diameter (particle diameter D50 at 50% of cumulative volume in a volume particle size distribution) of a graphitization-retardant carbon can be, for example, 3 to 20 μm, and desirably 5 to 15 μm, from the viewpoint of improvement in filling properties of the negative-electrode active material in the negative electrode, and in reducing or eliminating side reaction with electrolyte (molten salt). In addition, the specific surface area of a graphitization-retardant carbon can be, for example, 1 to 10 m²/g, and preferably 3 to 8 m²/g, from the viewpoint of ensuring acceptability of sodium ions, and in reducing or eliminating side reaction with the electrolyte. Graphitization-retardant carbons can be used alone or in admixture of a plural kinds thereof.

The negative-electrode active material layer 3b can be a mixed-agent layer which contains the negative-electrode active material active material as an essential component, and a binder, an electrically conductive material, and/or the like, as optional components. The binder and the electrically conductive material used in the negative electrode can be those that have been described by way of example as components of the positive electrode. The content of the binder is preferably 1 to 10 parts by mass, and more preferably 3 to 5 parts by mass, per 100 parts by mass of the negative-electrode active material. The content of the electrically conductive material is preferably 5 to 15 parts by mass, and more preferably 5 to 10 parts by mass, per 100 parts by mass of the negative-electrode active material.

One preferred embodiment of the negative electrode 3 can be exemplified by a negative electrode including a negative-electrode current collector 3a formed of aluminum or aluminum alloy, and a negative-electrode active material layer 3b, covering at least a portion of the surface of the negative-electrode current collector, and formed of zinc, zinc alloy, tin, or tin alloy. Such negative electrode has a high capacity, and has long-term aging resistance.

### Separator

A separator can be provided between the positive electrode and the negative electrode. The material of the separator can be selected in consideration of the working temperature of the battery. However, from the viewpoint of reducing or eliminating side reaction with the molten salt electrolyte, it is preferable that a glass fiber, a silica-containing polyolefin, fluororesin, alumina, polyphenylene sulfite (PPS), or the like is used. Among them, a nonwoven fabric made of a glass fiber is preferred, from the viewpoint of low cost and high heat resistance. In addition, the silica-containing polyolefin and the alumina are preferred, from the viewpoint of excellent heat resistance. Moreover, the fluororesin and the PPS are preferred, from the viewpoint of heat resistance and corrosion resistance. In particular, PPS is highly resistant to fluorine contained in the molten salt.

The thickness of the separator is preferably 10 μm to 500 μm, and more preferably 20 to 50 μm. This is because this range of thickness can effectively prevent an internal short-circuit, and reduce the volume occupancy of the separator in the electrode unit to a low value, and thus high capacity density can be obtained.

### Electrode Unit

The molten salt battery is used in a state where an electrode unit including the positive and negative electrodes described above, and the molten salt electrolyte have been housed in a battery casing. The electrode unit is formed by laminating or winding the positive and negative electrodes with the separator interposed therebetween. In this regard, by using a metallic battery casing and providing electrical continuity between either one of the positive electrode or the negative electrode and the battery casing, a portion of the battery casing can be used as a first external terminal. Meanwhile, the other one of the positive electrode or the negative electrode is connected, by using a lead piece or the like, to a second external terminal drawn out of the battery casing while the second external terminal is electrically insulated from the battery casing.

Next, a configuration of a molten salt battery (sodium molten salt battery) according to one embodiment of the present invention will be described. However, the configuration of a molten salt battery according to the present invention is not limited to the configuration described below.

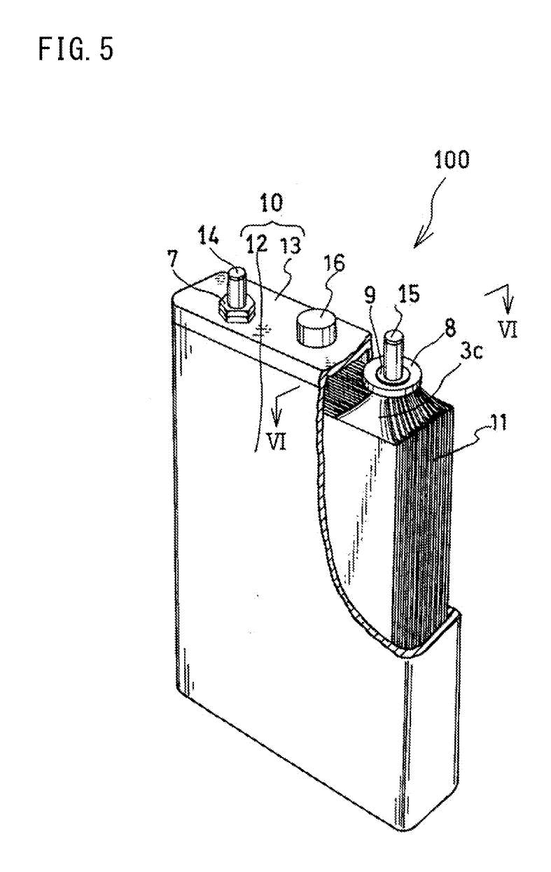

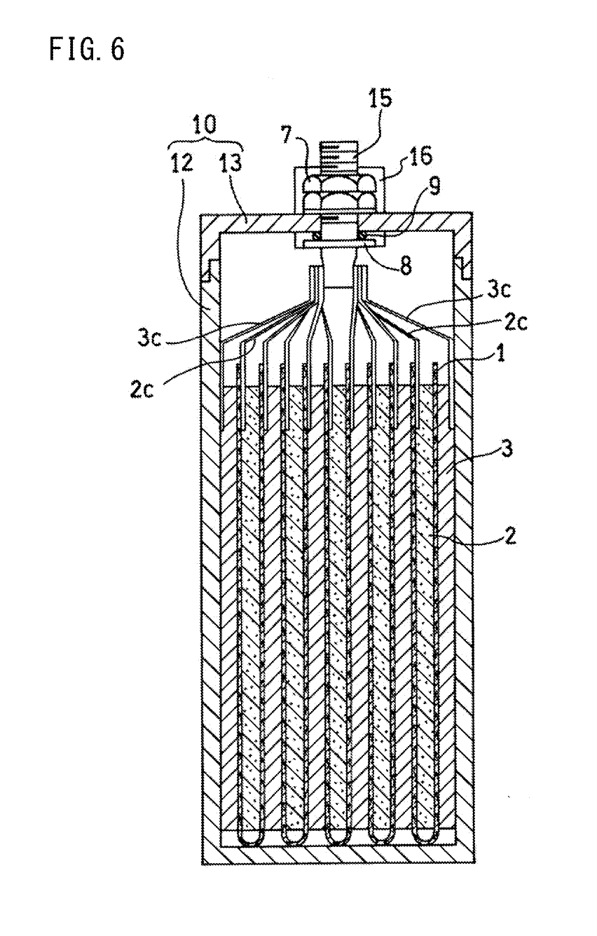

FIG. 5 is a perspective view of a molten salt battery 100 after cutting off a portion of the battery casing, and FIG. 6 is a vertical cross-sectional view schematically illustrating a cross section taken along line VI-VI of FIG. 5.

The molten salt battery 100 includes an electrode unit 11 of a lamination type, an electrolyte (not shown), and a prismatic battery casing 10, made of aluminum, that houses these. The battery casing 10 is formed from a bottomed container body 12 with an upper portion opened, and a lid part 13 that covers the upper opening. When the molten salt battery 100 is assembled, the electrode unit 11 is first formed, and is then inserted into the container body 12 of the battery casing 10.

Thereafter, a process is performed to apply the molten salt electrolyte into the container body 12, and impregnate the molten salt electrolyte into the gaps between the separators 1 and the positive electrodes 2 and the negative electrodes 3 included in the electrode unit 11. Alternatively, the process can be such that the molten salt electrolyte is impregnated into the electrode unit 11, and the electrode unit 11 containing the molten salt electrolyte is inserted into the container body 12.

An external positive electrode terminal 14 which penetrates through the lid part 13, and is electrically insulated from the battery casing 10, is provided on one near-end portion of the lid part 13. An external negative electrode terminal 15 which penetrates through the lid part 13, and is electrically conductive with the battery casing 10, is provided on the other near-end portion of the lid part 13. A safety valve 16 for releasing gas generated in the interior when the inner pressure of the battery casing 10 rises is provided at a center of the lid part 13.

The electrode unit 11 of a lamination type includes a plurality of positive electrodes 2 and a plurality of negative electrodes 3, both of which are rectangular sheets, and a plurality of separators 1 interposed between respective pairs thereof. Although FIG. 6 illustrates the separators 1 as each being a bag-like enclosure around one of the positive electrodes 2, the configuration of the separators are not necessarily limited. The plurality of positive electrodes 2 and the plurality of negative electrodes 3 are disposed in alternation with one another along the laminating direction in the electrode unit 11.

A positive-electrode lead piece 2c can be formed on one end portion of each of the positive electrodes 2. Bundling together the positive-electrode lead pieces 2c of the plurality of positive electrodes 2, and connecting the bundle portion to the external positive electrode terminal 14 provided on the lid part 13 of the battery casing 10 forms parallel connection of the plurality of positive electrodes 2. Similarly, a negative-electrode lead piece 3c can be formed on one end portion of each of the negative electrodes 3. Bundling together the negative-electrode lead pieces 3c of the plurality of negative electrodes 3, and connecting the bundle portion to the external negative electrode terminal 15 provided on the lid part 13 of the battery casing 10 forms parallel connection of the plurality of negative electrodes 3. It is desirable that the bundle of the positive-electrode lead pieces 2c and the bundle of the negative-electrode lead pieces 3c be disposed spaced apart from each other on the laterally opposite locations on one end surface of the electrode unit 11.

The external positive electrode terminal 14 and the external negative electrode terminal 15 are both column-like. At least each of portions thereof that are externally exposed has a thread groove. A nut 7 is placed in the thread groove of each of the terminals, and turning the nuts 7 secures the nuts 7 against the lid part 13. A collar 8 is provided in a region, inside the battery casing, of each of the terminals. Turning the nuts 7 secures the collars 8 against an inner surface of the lid part 13 via the washers 9.

### EXAMPLE

Next, the present invention will be described in more detail based on Example. Example described below is not intended to limit the scope of the invention.

### Example 1

### Synthesis of Positive-Electrode Active Material

Na₂CO₃, FeC₂O₄. 2H₂O, and (NH₄)₂HPO₄ were mixed in acetone for 8 hours using a planetary ball mill. The resulting mixture was subjected to a heat treatment at 300° C. for 6 hours in argon, and then fired at 600° C. for 12 hours to obtain Na₂FeP₂O₇.

### Production of Positive Electrode

Eighty-five parts by mass of Na₂FeP₂O₇ having an average particle diameter of 5 μm (positive-electrode active material), 10 parts by mass of acetylene black (electrically conductive agent), and 5 parts by mass of PTFE (binder) were dispersed in N-methyl-2-pyrrolidone (NMP) to prepare positive electrode paste. The resulting positive electrode paste was applied on the both sides of an aluminum mesh having a thickness of 50 μm, which was then sufficiently dried and rolled to produce a positive electrode having a total thickness of 100 μm and including a 50-μm thickness of the positive-electrode mixed-agent layers on both sides. The positive electrode was stamped out into a shape of coin having a diameter of 14 mm.

### Production of Negative Electrode

A metal sodium disk (manufactured by Aldrich, thickness: 200 μm) was press-bonded to a nickel current collector to produce a negative electrode having a total thickness of 700 μm. The negative electrode was stamped out into a shape of coin having a diameter of 12 mm.

### Separator

A separator made of a glass microfiber (manufactured by Whatman, Grade GF/A, thickness: 260 μm) was prepared.

### Molten Salt Electrolyte

A molten salt electrolyte was prepared which was a mixture having a molar ratio of sodium bis(fluorosulfonyl)amide (Na.FSA) to potassium bis(fluorosulfonyl)amide (K.FSA) of 56:44 (Na.FSA:K.FSA).

### Assembly of Molten Salt Battery

A coin-type positive electrode, a negative electrode and a separator were heated at a temperature of 90° C. or higher under a reduced pressure of 0.3 Pa to sufficiently dry. Then, a coin-type negative electrode was placed in a shallow cylindrical container made of Al/SUS clad. A coin-type positive electrode was placed on the negative electrode with a coin-type separator interposed therebetween. A predetermined amount of molten salt electrolyte was applied into the container. Then, the opening of the container was sealed by a shallow cylindrical sealing plate made of Al/SUS clad having an insulation gasket on the periphery. This applied pressure on the electrode unit, which was formed of the negative electrode, separator, and positive electrode, between the bottom of the container and the sealing plate to ensure contact between the members. As a result, a coin-type battery (half cell) having a design capacity of 1.5 mAh was produced.

### Comparative Example 1

A coin-type battery was produced in the same manner as in Example 1 except that a propylene carbonate solution containing NaClO₄ at a concentration of 1 mol/L was used as the electrolyte.

### Evaluation

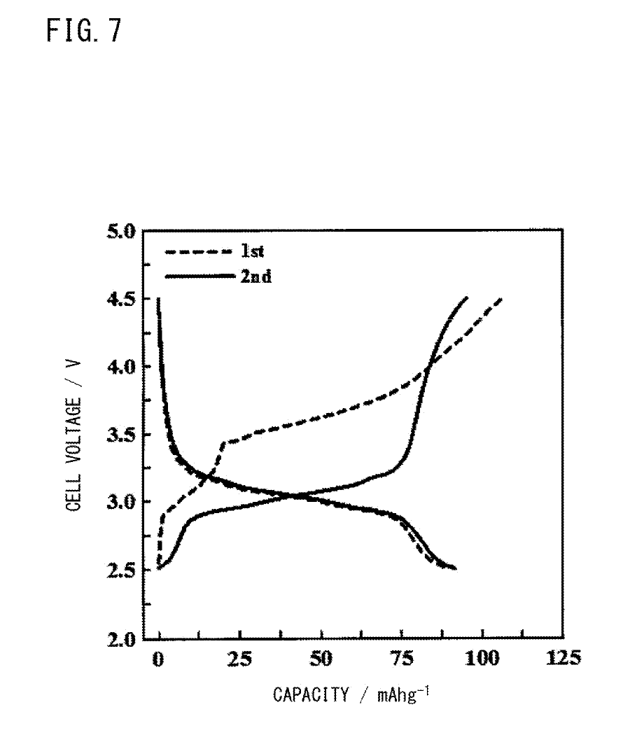

Each of the coin-type batteries of Example 1 and Comparative Example 1 was heated in a constant temperature chamber until 90° C. was reached. After the temperature had been stabilized, charging and discharging was performed in cycles of the conditions (1) and (2) described below. Charge and discharge curves for the first and second cycles of the coin-type battery of Example 1 are shown in FIG. 7.

(1) 90° C., current density 10 mA/g (equivalent to current value of 0.1 C), charge to a charge termination voltage of 4.5 V, and

(2) 90° C., current density 10 mA/g (equivalent to current value of 0.1 C), discharge to a discharge termination voltage of 2.5 V.

From the graph, it can be seen that charging and discharging was stably performed even in an environment of 90° C. The coin-type battery of Comparative Example 1 could not be charged and discharged, because the electrolyte decomposed to generate gas.

### Evaluation 2

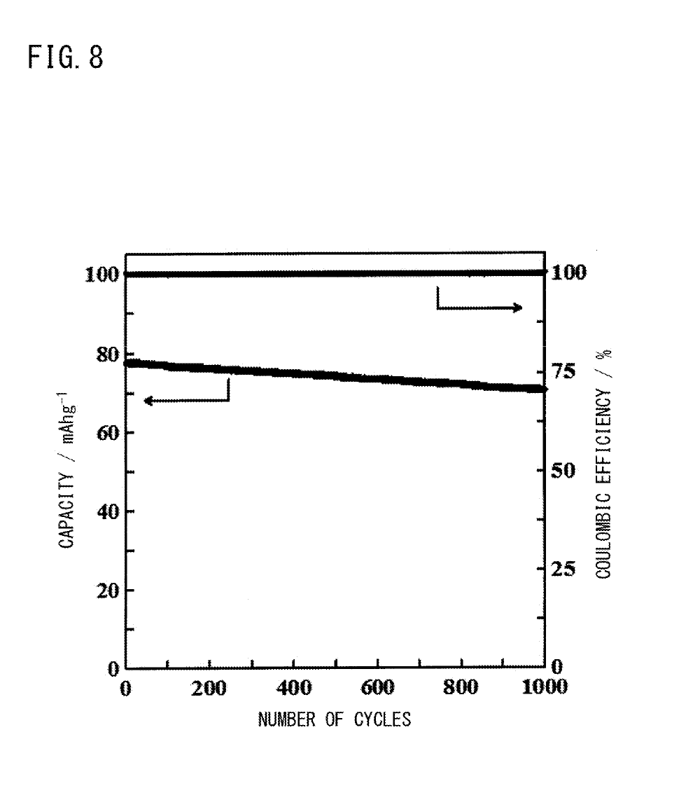

The discharge capacity and the ratio of the discharge capacity to the charge capacity (coulombic efficiency) of each cycle of the coin-type battery of Example 1 were obtained by performing 1000 cycles of charging and discharging in a similar conditions to those of Evaluation 1 except that the current density was 100 mA/g (equivalent to current value of 1 C). The results are shown in FIG. 8. Even after 1000 cycles, the discharge capacity was 71 mAh/g. This is 91% of the discharge capacity in the first cycle (78 mAh/g), which shows a high retention rate of the capacity. In addition, the coulombic efficiency was constantly kept at or above 99.9% during 1000 cycles.

### Evaluation 3

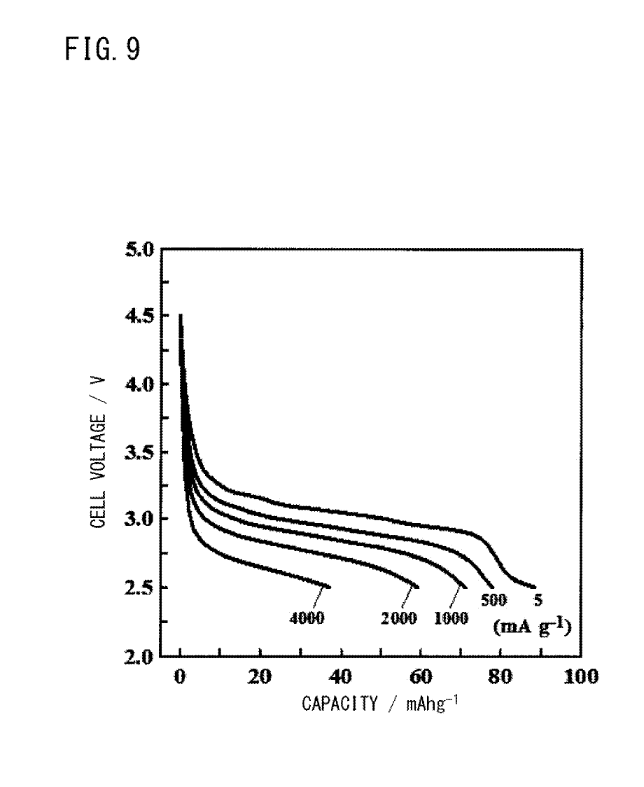

The discharge capacity of the coin-type battery of Example 1 at 90° C. was measured with current densities of 5 mA/g, 500 mA/g (equivalent to 5 C), 1000 mA/g (equivalent to 10 C), 2000 mA/g (equivalent to 20 C), and 4000 mA/g (equivalent to 40 C). The results are shown in FIG. 9. High values of discharge capacity were observed such as about 90 mAh/g at a current density of 5 mA/g, about 80 mAh/g at a current density of 500 mA/g, and about 60 mAh/g at a current density of 2000 mA/g.

### INDUSTRIAL APPLICABILITY

Since a molten salt battery according to the present invention exhibits excellent charge/discharge cycle characteristics, the molten salt battery according to the present invention is useful for applications that demand long-term reliability, such as, for example, as a power source for a large-scale power storage device for residential or industrial use, an electric car, hybrid car, or the like.

### REFERENCE SIGNS LIST

1: Separator
2: Positive Electrode
2a: Positive-Electrode Current Collector
2b: Positive-Electrode Active Material Layer
2c: Positive-Electrode Lead Piece
3: Negative Electrode
3a: Negative-Electrode Current Collector
3b: Negative-Electrode Active Material Layer
3c: Negative-Electrode Lead Piece
7: Nut
8: Collar
9: Washer
10: Battery Casing
11: Electrode Unit
12: Container Body
13: Lid Part
14: External Positive Electrode Terminal
15: External Negative Electrode Terminal
16: Safety Valve
100: Molten Salt Battery

1. A molten salt battery comprising:
a positive electrode including a positive-electrode active material represented by the general formula:
Aₙ₍₁₋ₓ₎M¹ₙₓ(Fe_{1-y}M²_{y}P₂O₇
wherein n is 1 or 2; 0≦x≦0.5, 0≦y≦0.5, A is an alkali metal element, M¹ is an element other than the element A, and M² is an element other than Fe;
a negative electrode including a negative-electrode active material;
a separator interposed between the positive electrode and the negative electrode; and
a molten salt electrolyte,
wherein the molten salt electrolyte contains 90% by mass or more of an ionic liquid containing a salt of the element A.

2. The molten salt battery according to claim 1, wherein the positive-electrode active material is Na₂₋₂ₓM¹₂ₓFe_{1-y}M²_{y}P₂O₇
wherein 0≦x≦0.1; 0≦y≦0.1, M¹ is an element other than sodium, and M² is an element other than Fe, and
wherein a salt of the element A is a sodium salt.

3. The molten salt battery according to claim 2, wherein the positive-electrode active material is Na₂FeP₂O₇.

4. The molten salt battery according to claim 1, wherein the ionic liquid contains a salt of an anion and a cation, the anion being represented by the general formula:
[(R¹SO₂)(R²SO₂)]N⁻
wherein each of R¹ and R² is independently F or CₙF₂ₙ₊₁, and 1≦n≦5.

5. The molten salt battery according to claim 1, wherein the negative-electrode active material is at least one selected from a group consisting of an element A-containing titanium compound, and a graphitization-retardant carbon.
